(19) United States
(12) Patent Application Publication
(10) Pub. No.: US 2014/0049234 A1
(43) Pub. Date: Feb. 20, 2014

(54) REGULATOR FOR CONTROLLING OUTPUT VOLTAGE

(71) Applicant: Samsung Electro-Mechanics Co., Ltd., Suwon (KR)

(72) Inventors: Tah Joon PARK, Suwon (KR); Yong Il KWON, Suwon (KR)

(73) Assignee: SAMSUNG ELECTRO-MECHANICS CO., LTD.

(21) Appl. No.: 13/913,370

(22) Filed: Jun. 7, 2013

(30) Foreign Application Priority Data
Aug. 14, 2012 (KR) 10-2012-0089077

(51) Int. Cl. G05F 1/10

(52) U.S. Cl. CPC G05F 1/10
USPC 323/265

(57) ABSTRACT

There is provided a regulator for controlling an output voltage, capable of stabilizing the voltage output from the regulator. The regulator for controlling an output voltage may include an output current generating unit generating an output current according to a reference voltage, an output voltage detecting unit detecting an output voltage using the output current, according to resistors provided therein, and a controlling unit comparing the output voltage with a preset reference output voltage to control the reference voltage.

### CROSS-REFERENCE TO RELATED APPLICATIONS

This application claims the priority of Korean Patent Application No. 10-2012-0089077 filed on Aug. 14, 2012, in the Korean Intellectual Property Office, the disclosure of which is incorporated herein by reference.

### BACKGROUND OF THE INVENTION

1. Field of the Invention

The present invention relates to a regulator for controlling an output voltage.

2. Description of the Related Art

A method for increasing power efficiency in an electronic device includes a method of minimizing current consumption in a sleep mode. Generally, in order to supply current required for the sleep mode, a low power regulator is used. However, when voltage output from the regulator is changed due to influences of process deviation, the temperature of a surround environment, or the like, the current flowing in the sleep mode may be changed due to the changed output voltage, such that high efficiency may not be achieved in terms of power. Therefore, in order to achieve a high degree of power efficiency, it is necessary to stabilize the voltage output from the low power regulator.

Patent Document 1 of the following related art inventions relates to a microcomputer circuit for correcting a current value according to voltage changes, the microcomputer circuit correcting a current value error due to a reference voltage change in a microcomputer, and includes a constant voltage generator and the microcomputer correcting the current value error due to power voltage changes of the regulator based on a voltage reference value. In Patent Document 1, an output voltage change of the regulator is determined to thereby correct the current value error due to the output voltage change. However, Patent Document 1 does not disclose a method of stabilizing the voltage output from the regulator.

[Related Art Document]

(Patent Document 1) Korean Patent Laid-Open Publication No. 10-2011-0072389

### SUMMARY OF THE INVENTION

An aspect of the present invention provides a regulator for controlling an output voltage, capable of stabilizing the voltage output from the regulator by changing a reference voltage applied to an operational amplifier, a component of the regulator according to the voltage output therefrom.

According to an aspect of the present invention, there is provided a regulator for controlling an output voltage, including: an output current generating unit generating an output current according to a reference voltage; an output voltage detecting unit detecting an output voltage using the output current, according to resistors provided therein; and a controlling unit comparing the output voltage with a preset reference output voltage to control the reference voltage.

The output current generating unit may include: a reference voltage generating unit generating the reference voltage; an operational amplifier including an inverting input terminal and a non-inverting input terminal to which the reference voltage is applied; and a transistor generating the output current using a gate voltage output from an output terminal of the operational amplifier and a preset driving power.

The reference voltage generating unit may include: a current mirror unit driven by the driving power to generate a reference current, and generating the reference voltage according to an amplitude of the reference current; and a variable resistor positioned between the current mirror unit and the driving power, and varying the reference voltage according to a resistance value.

The transistor may include: a gate to which the gate voltage is input; a source to which the driving power is applied; and a drain from which the output voltage is output.

The output voltage detecting unit may include a first resistor and a second resistor to which the output current is applied and detect the output voltage according to a resistance ratio of the first resistor and the second resistor.

The first resistor may be positioned between the drain of the transistor and the non-inverting input terminal of the operational amplifier, and the second resistor may be positioned between the non-inverting input terminal of the operational amplifier and a ground.

The controlling unit may compare the output voltage with the preset reference output voltage to control the reference voltage such that the output voltage has a level equal to that of the preset reference output voltage.

The controlling unit may control the reference voltage by varying the resistance value of the variable resistor.

The regulator for controlling an output voltage may further include an analog to digital converter converting the output voltage into a digital signal, wherein the controlling unit may compare the digital signal with a preset reference digital signal to control the reference voltage.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing a regulator for controlling an output voltage according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

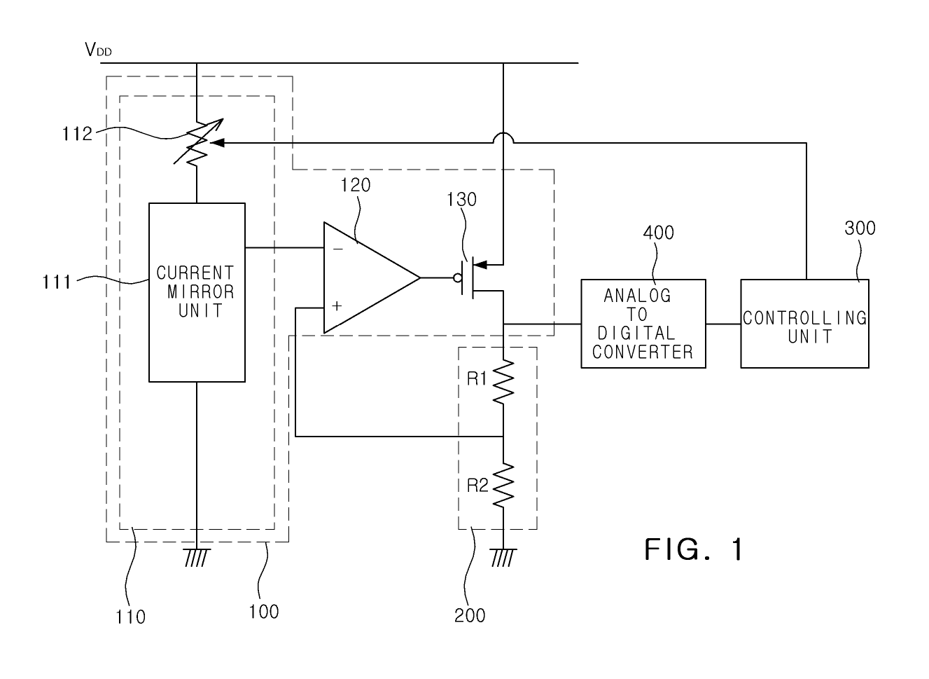

FIG. 1 is a block diagram showing a regulator for controlling an output voltage according to an embodiment of the present invention.

Referring to FIG. 1, a regulator for controlling an output voltage according to the embodiment of the present invention may include an output current generating unit 100, an output voltage detecting unit 200, and a controlling unit 300. The output current generating unit 100 may generate an output current according to a reference voltage, the output voltage detecting unit 200 may detect an output voltage using the output current according to resistors provided therein, and the controlling unit 300 may compare the output voltage with a preset reference output voltage to control the reference voltage.

The output current generating unit 100 may include a reference voltage generating unit 110 generating the reference voltage, an operational amplifier 120, and a transistor 130.

The reference voltage generating unit 110 may include a current mirror unit 111, driven by a driving power and generating a reference current. The reference voltage may be generated by a flow of the reference current generated by the current mirror unit 111. In addition, the reference voltage generating unit 110 may include a variable resistor 112 positioned between the current mirror unit 111 and the driving power. The reference current may be changed according to a change in a resistance value of the variable resistor 112 and the reference voltage may also be varied by the change of the reference current.

The operational amplifier 120 may include an inverting input terminal and a non-inverting input terminal to which the reference voltage generated by the reference voltage generating unit 110 is applied. The same potential may be maintained in the inverting input terminal and the non-inverting terminal according to the virtual ground principle of the operational amplifier 120.

In addition, the transistor 130 may generate the output current according to a voltage difference between a gate voltage output from an output terminal of the operational amplifier 120 and a preset driving power. Specifically, the transistor 130 may include a gate to which the gate voltage is input, a source to which the driving power is applied, and a drain from which the output voltage is output. The transistor 130 is shown as a P-MOS FET in FIG. 1, but it is merely provided by way of example and it is not limited thereto.

The output voltage detecting unit 200 may have a first resistor R1 and a second resistor R2 to which the output current is applied and may detect the output voltage according to a resistance ratio of the first resistor R1 and the second resistor R2. Specifically, the first resistor R1 may be positioned between the drain of the transistor 130 and the non-inverting input terminal of the operational amplifier 120 and the second resistor R2 may be positioned between the non-inverting input terminal and a ground.

The detected output voltage may be converted into a digital signal by an analog to digital converter. The controlling unit 300 may compare the digital signal output from the analog to digital converter with a preset reference digital signal to thereby control the reference voltage input to the inverting input terminal of the operational amplifier 120 such that the digital signal output from the analog to digital converter is equal to the reference digital signal. In order to control the reference voltage, the controlling unit 300 may vary the resistance value of the variable resistor 112 positioned between the driving power and the current mirror unit 111 to thereby control the reference voltage.

Although FIG. 1 shows a case in which the controlling unit 300 receives the output voltage through the analog to digital converter, the controlling unit 300 may receive the output voltage detected from the output voltage detecting unit 200 directly. The reference voltage input to the inverting input terminal of the operational amplifier 120 may be controlled such that the output voltage has a level equal to that of the preset reference output voltage by comparing the detected output voltage with the preset reference output voltage. In order to control the reference voltage, the controlling unit 300 may vary the resistance value of the variable resistor 112 positioned between the driving power and the current mirror unit 111 to thereby control the reference voltage.

As set forth above, according to the embodiment of the present invention, a regulator for controlling an output voltage, capable of stabilizing the voltage output from the regulator by changing a reference voltage applied to an operational amplifier, a component of the regulator according to the voltage output therefrom, can be provided.

While the present invention has been shown and described in connection with the embodiments, it will be apparent to those skilled in the art that modifications and variations can be made without departing from the spirit and scope of the invention as defined by the appended claims.

What is claimed is:

1. A regulator for controlling an output voltage, comprising:
an output current generating unit generating an output current according to a reference voltage;
an output voltage detecting unit detecting an output voltage using the output current, according to resistors provided therein; and
a controlling unit comparing the output voltage with a preset reference output voltage to control the reference voltage.

2. The regulator for controlling an output voltage of claim 1, wherein the output current generating unit includes:
a reference voltage generating unit generating the reference voltage;
an operational amplifier including an inverting input terminal and a non-inverting input terminal to which the reference voltage is applied; and
a transistor generating the output current using a gate voltage output from an output terminal of the operational amplifier and a preset driving power.

3. The regulator for controlling an output voltage of claim 2, wherein the reference voltage generating unit includes:
a current mirror unit driven by the driving power to generate a reference current, and generating the reference voltage according to an amplitude of the reference current; and
a variable resistor positioned between the current mirror unit and the driving power, and varying the reference voltage according to a resistance value.

4. The regulator for controlling an output voltage of claim 2, wherein the transistor includes:
a gate to which the gate voltage is input;
a source to which the driving power is applied; and
a drain from which the output voltage is output.

5. The regulator for controlling an output voltage of claim 4, wherein the output voltage detecting unit includes a first resistor and a second resistor to which the output current is applied and detects the output voltage according to a resistance ratio of the first resistor and the second resistor.

6. The regulator for controlling an output voltage of claim 5, wherein the first resistor is positioned between the drain of the transistor and the non-inverting input terminal of the operational amplifier; and the second resistor is positioned between the non-inverting input terminal of the operational amplifier and a ground.

7. The regulator for controlling an output voltage of claim 1, wherein the controlling unit compares the output voltage with the preset reference output voltage to control the reference voltage such that the output voltage has a level equal to that of the preset reference output voltage.

8. The regulator for controlling an output voltage of claim 3, wherein the controlling unit controls the reference voltage by varying the resistance value of the variable resistor.

9. The regulator for controlling an output voltage of claim 1, further comprising an analog to digital converter converting the output voltage into a digital signal,
wherein the controlling unit compares the digital signal with a preset reference digital signal to control the reference voltage.
